(19) United States
(12) Patent Application Publication
(10) Pub. No.: US 2026/0351572 A1
(43) Pub. Date: Nov. 5, 2026

(54) POSITIVE ELECTRODE MATERIAL FOR LITHIUM ION BATTERY, PREPARATION METHOD THEREFOR, POSITIVE ELECTRODE AND LITHIUM ION SECONDARY BATTERY

(71) Applicant: MURATA MANUFACTURING CO., LTD., Kyoto (JP)

(72) Inventors: Yan ZHOU, Shanghai (CN); Li WANG, Shanghai (CN); Yuli LI, Shanghai (CN); Haipeng GUO, Shanghai (CN)

(21) Appl. No.: 19/468,599

(22) Filed: Feb. 3, 2026

(30) Foreign Application Priority Data
Mar. 25, 2025 (CN) 2025103607298

(51) Int. Cl. H01M 4/36; H01M 4/02; H01M 4/04; H01M 4/131; H01M 4/525; H01M 10/0525

(52) U.S. Cl. CPC H01M 4/366; H01M 4/0471; H01M 4/131; H01M 4/525; H01M 10/0525; H01M 2004/028

(57) ABSTRACT

A positive electrode material for a lithium ion battery, a preparation method therefor, a positive electrode and a lithium ion secondary battery are provided. The positive electrode material for a lithium ion battery includes a positive electrode active material; an organic acid lithium salt, a fast ion conductor lithium salt compound, and an inert fluoride which coat particles of the positive electrode active material; wherein the organic acid lithium salt is in contact with a secondary particle surface and a primary particle grain boundary of the positive electrode active material, the inert fluoride and the fast ion conductor lithium salt compound are dispersed on the secondary particle surface of the positive electrode active material and are both in contact with the secondary particle surface of the positive electrode active material, and the inert fluoride and the fast ion conductor lithium salt compound are in contact with each other.

### CROSS REFERENCE TO RELATED APPLICATIONS

The present application claims priority to Chinese patent application no. 2025103607298, filed on Mar. 25, 2025, the entire contents of which are incorporated herein by reference.

### BACKGROUND

The present application relates to the field of lithium ion secondary batteries, and in particular, to a positive electrode material for a lithium ion battery, a preparation method therefor, and a positive electrode and a lithium ion secondary battery which include the positive electrode material.

In recent years, with the continuous update of electronic technology, demand for a battery apparatus supporting energy supply of electronic devices is increasing continuously. Today, batteries capable of storing more electricity and capable of outputting high power are needed. Conventional lead-acid batteries and nickel-hydrogen batteries, etc. have been unable to meet the requirements of new electronic products. Therefore, lithium batteries have attracted wide attention. In the development process of lithium ion batteries, the capacity and performance thereof have been improved effectively.

In the field of lithium batteries, high-nickel ternary positive electrode materials with high energy density have certain advantages in the power battery market. However, with the increasing demand for endurance mileage of electric vehicles, the molar proportion of nickel in the ternary positive electrode material has been increased to 90% or more, which not only increases residual alkali (LiOH and/or Li₂CO₃) on the surface of the positive electrode material, resulting in problems such as difficulty in processing and serious air generation, but also further exacerbating the instability of a positive electrode interface/structure, thus worsening the capacity retention rate. In addition, increased internal resistance caused by the increased nickel content makes it more difficult for the battery to get rid of range anxiety and to satisfy the fast charge requirement on the market. Therefore, a high-performance high-nickel positive electrode material having high energy density, good cycle stability, and low impedance is a key and difficult point of research nowadays.

Currently, although the mainstream water washing modified or acid washing modified high-nickel material can reduce the residual alkali on the surface, NiO-based substances will be generated on the surface of the water washed material, resulting in increased impedance, and the problem of precipitation of lattice lithium exists, such that the structure of the positive electrode material is unstable due to the water washing modification or acid washing modification, and the cycle performance deteriorates. Nowadays, the most effective policy for improving the cycle stability of the high-nickel material is to coat the surface of the high-nickel material with stable materials, such as metal oxides and fluorides, to act as a physical barrier layer, but these substances lack the ability of conducting electrons or ions, resulting in increased battery impedance and poor rate capability. At present, the most effective policy for ameliorating the internal resistance of a battery is to coat materials with good ion/electron transport properties, such as solid electrolytes, phosphates and carbon polymers, onto the surface of the high-nickel material to promote the ion/electron transport capability, but such materials cannot inhibit microcracks and side reactions of the positive electrode, resulting in poor cycle performance.

In view of the existence of the problems, it is necessary to develop a positive electrode material for a lithium ion battery, a preparation method therefor, a positive electrode and a lithium ion secondary battery, so as to solve the problem of poor electrochemical performance (such as capacity, impedance, and cycle stability) of lithium batteries, especially lithium batteries using high-nickel positive electrode materials.

### SUMMARY

The present application relates to providing, in an embodiment, a positive electrode material for a lithium ion battery, a preparation method therefor, a positive electrode and a lithium ion secondary battery, so as to solve the problem of poor electrochemical performance (such as capacity, impedance, and cycle stability) of lithium batteries, especially lithium batteries using high-nickel positive electrode materials.

In an embodiment of the present application, provided is a positive electrode material for a lithium ion battery, the positive electrode material including:
a positive electrode active material; and
an organic acid lithium salt, a fast ion conductor lithium salt compound, and an inert fluoride which coat particles of the positive electrode active material;
wherein the organic acid lithium salt is in contact with a secondary particle surface and a primary particle grain boundary of the positive electrode active material, the inert fluoride and the fast ion conductor lithium salt compound are dispersed on the secondary particle surface of the positive electrode active material and are both in contact with the secondary particle surface of the positive electrode active material, and the inert fluoride and the fast ion conductor lithium salt compound are in contact with each other.

Further, in the positive electrode material for the lithium ion battery, in an embodiment, the positive electrode active material is a high-nickel positive electrode material of a general formula LiNiₓM_{y}O₂, where x+y=1, 0.6≤x≤1, 0≤y≤0.4, and M is selected from one or more of Co, Mn, Al, Mg, Ti, Fe, Cu, Zn, Ga, Zr, Mo, Nb and W.

Further, in the positive electrode material for the lithium ion battery, in an embodiment, the organic acid lithium salt is a product of reaction between an organic acid and LiOH and/or Li₂CO₃ contained in the positive electrode active material, wherein the organic acid has a chemical formula of CₓH_{y}O_{z}, where 1≤x≤10, 2≤z≤4, and the organic acid contains 1-3 carboxyl groups and 0-1 C═C double bonds.

Further, in the positive electrode material for the lithium ion battery, in an embodiment, the organic acid includes one or more of maleic acid, acrylic acid, fumaric acid, malonic acid, oxalic acid, and malic acid.

Further, in the positive electrode material for the lithium ion battery, in an embodiment, the inert fluoride is a crystalline compound and has a chemical formula of MₓF_{y}, where M is selected from one or more of Al, Mg, Ca, Fe, La, Li, Ce, and Sr, and x and y are greater than 0.

Further, in the positive electrode material for the lithium ion battery, in an embodiment, the fast ion conductor lithium salt compound is a crystalline compound, and is selected from one or more of lithium aluminum titanium phosphate (LATP), lithium lanthanum titanate (LLTO), lithium lanthanum zirconium oxide (LLZO), and LiₓMO_{y}, where M is selected from one or more of Ti, Zr, Nb, and Ta, and x and y are greater than 0.

Further, in the positive electrode material for the lithium ion battery, in an embodiment, relative to a mass of the positive electrode active material, the inert fluoride has an amount of more than 0 and less than or equal to 1000 ppm.

Further, in the positive electrode material for the lithium ion battery, in an embodiment, the fast ion conductor lithium salt compound has an amount which is 1-20 times a mass of the inert fluoride.

According to another aspect of the present application, provided is a method for preparing the positive electrode material for a lithium ion battery as described above, the method including the following steps:
1) milling the inert fluoride and the fast ion conductor lithium salt compound to nanoscale particles;
2) mixing the milled inert fluoride and fast ion conductor lithium salt compound, an organic acid and a non-aqueous solvent to obtain a mixed solution;
3) adding the positive electrode active material into the mixed solution and stirring;
4) filtering the mixed solution to obtain a mixture; and
5) drying, milling and sieving, and calcining the mixture to obtain the positive electrode material.

According to another aspect of the present application, provided is a positive electrode for a lithium ion secondary battery, wherein the positive electrode for a lithium ion secondary battery includes the positive electrode material for a lithium ion battery as described above.

According to another aspect of the present application, provided is a lithium ion secondary battery, wherein the lithium ion secondary battery includes: a positive electrode, a negative electrode and a separator,
wherein the positive electrode includes the positive electrode material for a lithium ion battery as described above.

By the positive electrode material for a lithium ion battery, in an embodiment, the preparation method therefor, the positive electrode and the lithium ion secondary battery of the present application, the effect of improving the electrochemical performance (such as capacity, impedance, and cycle stability) of lithium batteries, especially lithium batteries using high-nickel positive electrode materials is achieved.

### BRIEF DESCRIPTION OF THE FIGURES

The drawings of the description, constituting a part of the present application, are used for providing further understanding of the present application, and the illustrative examples of the present application and illustrations thereof are used to explain the present application, and not a limitation on the present application. In the drawings:

FIG. 1 is a schematic drawing of a method for preparing a positive electrode material for a lithium ion battery according to the present application.

FIG. 2 is a schematic drawing of the structure of a positive electrode material for a lithium ion battery according to the present application.

### DETAILED DESCRIPTION

It is to be noted that examples in the present application and features in the examples may be combined with one another in any suitable manner. Hereinafter, the present application will be described in further detail with reference to figures and examples according to an embodiment.

As described in the Background, lithium batteries, especially lithium batteries using high-nickel positive electrode materials have the problem of poor electrochemical performance (such as capacity, impedance, and cycle stability). In view of same, according to an embodiment of the present application, a positive electrode material for a lithium ion battery is provided, the positive electrode material including:
a positive electrode active material; and
an organic acid lithium salt, a fast ion conductor lithium salt compound, and an inert fluoride which coat particles of the positive electrode active material;
wherein the organic acid lithium salt is in contact with a secondary particle surface and a primary particle grain boundary of the positive electrode active material, the inert fluoride and the fast ion conductor lithium salt compound are dispersed on the secondary particle surface of the positive electrode active material and are both in contact with the secondary particle surface of the positive electrode active material, and the inert fluoride and the fast ion conductor lithium salt compound are in contact with each other.

As described above, lithium batteries, especially lithium batteries using high-nickel positive electrode materials have the problem of poor electrochemical performance (such as capacity, impedance, and cycle stability). In particular, in battery electrode plates, the electron conduction ability and ion conduction ability are of great importance, since the prerequisite for charge exchange at a certain point on an interface of active particles and an electrolyte is both electrons and ions must reach a reaction site. However, since the specific surface area of the high-nickel material is small, it usually lacks the ion conduction ability, such that although the high-nickel material theoretically has a high capacity, it is difficult for an actually prepared battery to exert its theoretical performance. Furthermore, as stated above, the high-nickel material also has the problems of residual alkali, high impedance, and poor cycle performance. However, the technical solutions for solving these problems all have their respective disadvantages. In order to solve the problems, the present application provides, in an embodiment, a positive electrode material for a lithium ion battery, wherein a residual alkali value is decreased by reacting an organic acid with residual alkali on the surface of the positive electrode material to generate an organic acid lithium salt, and nanoparticles of an inert fluoride and fast ion conductor which are insoluble in organic alcohol solution are added to the positive electrode material and are coated on the surface of the high-nickel material in an island-like form. The positive electrode material for a lithium ion battery of the present application is washed with an organic acid, and only a trace amount of alkaline substances remain on the surface; the inert fluoride can increase the strength of the positive electrode material particles, improving the cycle stability, and inhibiting side reactions of the positive electrode material; and the fast ion conductor increases the ionic conductivity of the positive electrode material, accelerating ion transmission, and reducing battery impedance. Coatings of the two nanoparticles work together in the form of island-like coating, such that the two nanoparticles do not influence each other, thereby improving the electrochemical performance, such as capacity, impedance, and cycle stability, of the positive electrode material for a lithium ion battery of the present application. On the contrary, if the two nanoparticles were coated in other forms, for example, the inert fluoride was coated on the outside of the fast ion conductor, the conduction performance of the fast ion conductor will be affected, and the improvement on the electrochemical performance will be less significant.

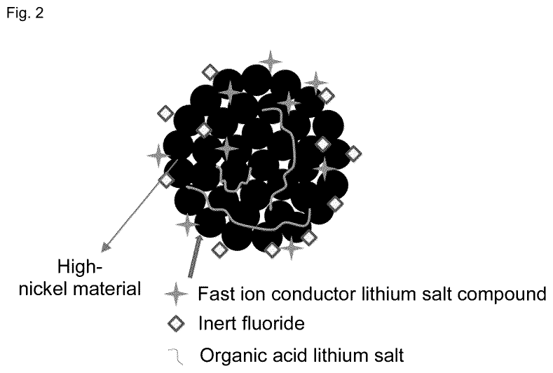

FIG. 2 is a schematic drawing of the structure of the positive electrode material for a lithium ion battery according to the present application. It can be seen from FIG. 2 that the organic acid lithium salt, the fast ion conductor lithium salt compound and the inert fluoride coat particles of the positive electrode active material together, wherein the organic acid lithium salt is in contact with a secondary particle surface and a primary particle grain boundary of the positive electrode active material, the inert fluoride and the fast ion conductor lithium salt compound are dispersed on the secondary particle surface of the positive electrode active material and are both in contact with the secondary particle surface of the positive electrode active material, and the inert fluoride and the fast ion conductor lithium salt compound are in contact with each other, that is, they coat the particles of the positive electrode material in an island-like form.

The inert fluoride refers to a fluoride which is a non-ionic/electronic conductor, has stable chemical properties, and is not very reactive. In the positive electrode material for a lithium ion battery of the present application, the nanoscale inert fluoride is distributed on the secondary particle surface of the positive electrode active material, thereby filling gaps between the particles, and enhancing the strength of the particles. During charging and discharging, lithium ions in the positive electrode material are continuously intercalated/deintercalated, which deforms the lattice, generating stress and causing cracks of the particles, and the increased particle strength will relieve the degree of particle cracking. During charging and discharging, LiPF₆ in the electrolyte solution is decomposed to generate HF, and the generated HF tends to erode the positive electrode material, resulting in gradual dissolution of transition metal ions on the material surface, thereby damaging the material surface. Coating the inert fluoride on the surface of the material reduces the contact area of the material and reduces side reactions on the one hand, and on the other hand, the property of the fluoride is stable, and a coating layer for protecting the positive electrode material can be formed.

The fast ion conductor is a solid conductor that can have conduction property similar to that of a liquid electrolyte over a certain temperature range. Applying the fast ion conductor to the positive electrode material can improve the ionic conductivity of the positive electrode material.

Therefore, in the positive electrode material for a lithium ion battery of the present application, the organic acid lithium salt, the fast ion conductor lithium salt compound, and the inert fluoride, which coat the particles of the positive electrode active material in a specific form, work together to reduce residual alkali on the surface of the positive electrode material, and improve the electrochemical performance of the positive electrode material, such as capacity, impedance, and cycle stability.

In a preferred embodiment, the positive electrode active material is a high-nickel positive electrode material of a general formula LiNiₓM_{y}O₂, where x+y=1, 0.6≤x≤1, 0≤y≤0.4, and M is selected from one or more of Co, Mn, Al, Mg, Ti, Fe, Cu, Zn, Ga, Zr, Mo, Nb and W.

As stated above, the present application preferably uses a high-nickel positive electrode material (wherein the molar ratio of nickel is greater than 80%), which has a higher theoretical capacity, and is more prone to the problems of incomplete capacity utilization, high impedance and poor cycle performance. Therefore, the present application is more advantageous in improving the electrochemical performance of the high-nickel positive electrode material. Moreover, the present application is not limited to the high-nickel positive electrode material, and also has an improved effect on other positive electrode materials. This is because the electrochemical performance is improved by the combination of the fluoride and the fast ion conductor, which depends more on the performance of the coating layer itself, and is not affected by the type of the positive electrode material.

In a preferred embodiment, in the positive electrode material for the lithium ion battery, the organic acid lithium salt is a product of reaction between an organic acid and LiOH and/or Li₂CO₃ contained in the positive electrode active material, wherein the organic acid has a chemical formula of CₓH_{y}O_{z}, where 1≤x≤10, 2≤z≤4, and the organic acid contains 1-3 carboxyl groups and 0-1 C═C double bonds.

In a preferred embodiment, in the positive electrode material for the lithium ion battery, the organic acid includes one or more of maleic acid, acrylic acid, fumaric acid, malonic acid, oxalic acid, and malic acid.

As mentioned above, the composition of residual alkali on the surface of the positive electrode material of the lithium ion battery is mainly LiOH and/or Li₂CO₃. It is expected that reaction with the organic acid can reduce the amount of residual alkali on the surface of the positive electrode material. The use of the preferred type of organic acid is further advantageous in achieving of the electrochemical performance of the positive electrode material.

In a preferred embodiment, in the positive electrode material for the lithium ion battery, the inert fluoride is a crystalline compound and has a chemical formula of MₓF_{y}, where M is selected from one or more of Al, Mg, Ca, Fe, La, Li, Ce, and Sr, and x and y are greater than 0.

In a preferred embodiment, in the positive electrode material for the lithium ion battery, the fast ion conductor lithium salt compound is a crystalline compound, and is selected from one or more of lithium aluminum titanium phosphate (LATP), lithium lanthanum titanate (LLTO), lithium lanthanum zirconium oxide (LLZO), and LiₓMO_{y}, where M is selected from one or more of Ti, Zr, Nb, and Ta, and x and y are greater than 0.

As described above, in the positive electrode material of the present application, the inert fluoride can increase the strength of the positive electrode material particles, improving the cycle stability, and inhibiting side reactions of the positive electrode material; and the fast ion conductor increases the ionic conductivity of the positive electrode material, accelerating ion transmission, and reducing battery impedance. Use of the preferred substances of inert fluoride and fast ion conductor as described above is further advantageous in achieving said effects. Furthermore, the crystalline inert fluoride requires a lower calcination temperature in the preparation, which can reduce costs; and the crystalline fast ion conductor has better conduction performance.

In a preferred embodiment, in the positive electrode material for the lithium ion battery, relative to a mass of the positive electrode active material, the inert fluoride has an amount of more than 0 and less than or equal to 1000 ppm.

In a preferred embodiment, in the positive electrode material for the lithium ion battery, the fast ion conductor lithium salt compound has an amount which is 1-20 times a mass of the inert fluoride.

In the positive electrode material for the lithium ion battery of the present application, the preferred contents of the inert fluoride and the fast ion conductor facilitate further improvement of the electrochemical performance of the positive electrode material.

According to another embodiment of the present application, provided is a method for preparing the positive electrode material for a lithium ion battery as described above, the method including the following steps:
1) milling the inert fluoride and the fast ion conductor lithium salt compound to nanoscale particles;
2) mixing the milled inert fluoride and fast ion conductor lithium salt compound, an organic acid and a non-aqueous solvent to obtain a mixed solution;
3) adding the positive electrode active material into the mixed solution and stirring;
4) filtering the mixed solution to obtain a mixture; and
5) drying, milling and sieving, and calcining the mixture to obtain the positive electrode material.

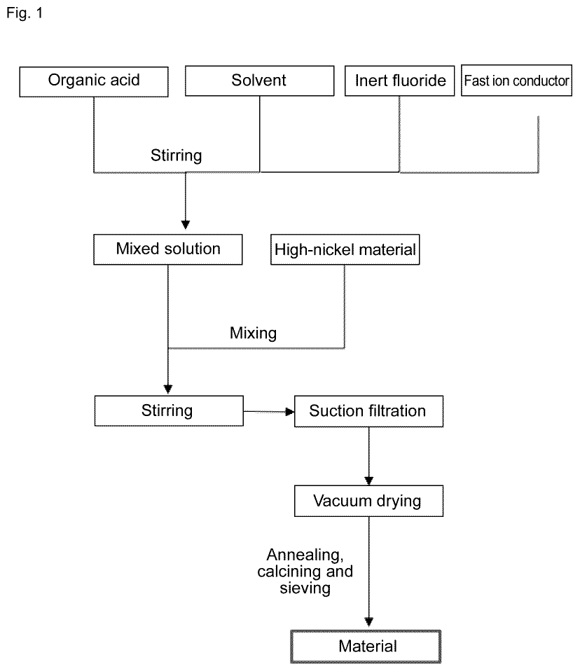

The method for preparing the positive electrode material for the lithium ion battery according to the present application is illustrated in FIG. 1. The specific preparation method of the present application achieves the positive electrode material including the organic acid lithium salt, the fast ion conductor lithium salt compound and the inert fluoride with the specific coating morphology as described above. In particular, milling the inert fluoride and fast ion conductor to nanoscale provides a precondition for uniform dispersion; and adding the two nanoscale coatings and the organic acid together into a solution and uniformly mixing with the positive electrode material achieve the distribution state of the present application.

According to another embodiment of the present application, provided is a positive electrode for a lithium ion secondary battery, wherein the positive electrode for a lithium ion secondary battery includes the positive electrode material for a lithium ion battery.

According to another embodiment of the present application, provided is a lithium ion secondary battery, wherein the lithium ion secondary battery includes: a positive electrode, a negative electrode and a separator,
wherein the positive electrode includes the positive electrode material for a lithium ion battery as described above.

Hereinafter, the present application will be further described in detail in combination with specific examples, without limitation, according to an embodiment.

### EXAMPLES

### Example 1

A positive electrode material and a lithium ion battery were prepared by the following steps.
(1) 5 g of AlF₃ and LiNbO₃ were respectively weighed, and ball-milled and mixed for 3 h at a ball-milling media to material ratio of 1:5, a rotational speed of 500 rpm, so as to obtain nanoparticles respectively; 2 g of maleic acid and 98 g of anhydrous ethanol were stirred for 1 h to obtain a maleic acid ethanol solution;
(2) 50 g of lithium nickel cobalt aluminum layered oxide as a high-nickel material, and nanopowders of 250 ppm of AlF₃ and 5000 ppm of LiNbO₃ with respect to the high-nickel material were weighed, and added into 50 g of the maleic acid ethanol solution, and stirred at 50-500 rpm for 1 h to obtain a mixed solution;
(3) suction filtration was performed on the mixed solution in step (2), the obtained solid matter was placed into a vacuum drying oven for drying at 120 °C for 8 h, and milling and sieving were performed to obtain an acid-washed high-nickel material;
(4) the acid-washed high-nickel material in step (3) was placed into a tube furnace for thermal treatment at a sintering temperature of 300 °C and sintering time of 4 hours, with temperature rising rate being 10 °C/min and the atmosphere being oxygen; after a sample was cooled, the sample was milled and sieved to obtain a coated high-nickel positive electrode material;
(5) preparation of a positive electrode plate from the positive electrode material: the positive electrode material of step (4), polyvinylidene fluoride (PVDF) and conductive carbon at a mass ratio of 90:5:5 were respectively weighed, the PVDF and conductive carbon were uniformly dissolved in N-methyl-2-pyrrolidone (NMP), and then the positive electrode material was added and stirred to prepare a slurry. After the slurry was uniformly stirred, an aluminum foil current collector was cleaned with anhydrous ethanol and then coated with the slurry, ensuring that the coating was uniform in thickness and bubble-free. The current collector coated with the slurry was placed in an air blast drying oven at 100 °C for air drying for 10 min. A slicing machine was used to cut the dried positive electrode plate into circular pieces having a diameter of about 15 mm.
(6) Battery assembly: in the examples, the electrochemical performance was tested by assembling the positive electrode plate into a button battery. In a dry room, the positive electrode plate prepared in step (5) and an electrolyte solution (50 μl) of LiPF₆+EC/DMC (at a volume ratio of 1:1) were added into a stainless steel case, which was then assembled into a button battery with a metal lithium sheet counter electrode, a Celgard2400 separator, and finally, battery packaging was performed using an MSK-110 button battery packaging machine, so as to obtain the battery.

The residual alkali content of the positive electrode material was measured using a residual alkali titrator.

The battery was placed in a channel of a charging and discharging device, a charging and discharging test was performed with the following parameters, for measuring the initial charge and discharge capacity, 10 C rate capacity retention rate and cycling capacity retention rate of the battery:
First charging: 0.1 C, 4.25 V; first discharging: 0.1 C, 2.0 V;
rate: 0.5 C, 4.25 V charging; and 0.2 C, 10 C, and 0.2 C discharging;
cycle: 60 °C, 1 C, 4.25V charging; and 5 C, 2.5 V discharging.

An impedance tester was used to measure the impedance of the battery before and after charging and discharging.

### Example 2

A lithium ion battery was prepared by the same steps as those in Example 1, except that LATP was used as the fast ion conductor, see Table 1 below.

### Example 3

A lithium ion battery was prepared by the same steps as those in Example 1, except that Li₂TiO₃ was used as the fast ion conductor, see Table 1 below.

### Example 4

A lithium ion battery was prepared by the same steps as those in Example 1, except that oxalic acid was used instead of maleic acid, and the amounts of the inert fluoride and the fast ion conductor were 500 ppm and 2500 ppm, respectively, seen Table 1 below.

### Example 5

A lithium ion battery was prepared by the same steps as those in Example 1, except that 1000 ppm of AlF₃ and 25000 ppm of LiNbO₃ were used, see Table 1 below.

### Example 6

A lithium ion battery was prepared by the same steps as those in Example 1, except that 250 ppm of AlF₃ and 200 ppm of LiNbO₃ were used, see Table 1 below.

### Example 7

A lithium ion battery was prepared by the same steps as those in Example 1, except that 30000 ppm of AlF₃ and 500 ppm of LiNbO₃ were used, see Table 1 below.

### Comparative Example 1

A lithium ion battery was prepared by the same steps as those in Example 1, except that no inert fluoride and fast ion conductor were used and there was no acid-washing step, see Table 1 below.

### Comparative Example 2

A lithium ion battery was prepared by the same steps as those in Example 1, except that water was used instead of maleic acid, see Table 1 below.

### Comparative Example 3

A lithium ion battery was prepared by the same steps as those in Example 1, except that no inert fluoride and fast ion conductor were used, see Table 1 below.

### Comparative Example 4

A lithium ion battery was prepared by the same steps as those in Example 1, except that fast ion conductor was not used, and only 5000 ppm of AlF₃ was used, see Table 1 below.

### Comparative Example 5

A lithium ion battery was prepared by the same steps as those in Example 1, except that fast ion conductor was not used, and only 10000 ppm of AlF₃ was used, see Table 1 below.

### Comparative Example 6

A lithium ion battery was prepared by the same steps as those in Example 1, except that no inert fluoride was used, and only 10000 ppm of LiNbO₃ was used, see Table 1 below.

### Comparative Example 7

A lithium ion battery was prepared by the same steps as those in Example 1, except that no inert fluoride was used, and only 20000 ppm of LiNbO₃ was used, see Table 1 below.

### Comparative Example 8

A lithium ion battery was prepared by the same steps as those in Example 1, except the differences as follows: in step (2), only a high-nickel material and AlF₃ were added and stirred to obtain a mixed solution, and then LiNbO₃ was added. In the positive electrode material prepared in this comparative example, the inert fluoride and the fast ion conductor were not distributed in an island-like form, but were distributed in two layers, wherein the fast ion conductor layer was located outside the inert fluoride layer.

### Comparative Example 9

A lithium ion battery was prepared by the same steps as those in Example 1, except the differences as follows: in step (2), only a high-nickel material and LiNbO₃ were added and stirred to obtain a mixed solution, and then AlF₃ was added; and in the positive electrode material prepared in this comparative example, the inert fluoride and the fast ion conductor were not distributed in an island-like form, but were distributed in two layers, wherein the inert fluoride layer was located outside the fast ion conductor layer.

TABLE 1

| | CE 1 | E 1 | E 2 | E 3 | E 4 | E 5 | E 6 | E 7 | CE 2 |
|---|---|---|---|---|---|---|---|---|---|
| Washing | — | Maleic | Maleic | Maleic | Oxalic | Maleic | Maleic | Maleic | Water |
| medium | | acid | acid | acid | acid | acid | acid | acid | |
| Distribution | — | One layer, island-like distribution | | | | | | | |
| state | | | | | | | | | |
| of coatings | | | | | | | | | |
| Coating | — | AlF3 + | AlF3 + | AlF3+ | AlF3 + | AlF3+ | AlF3 + | AlF3 + | AlF3 + |
| | | LiNbO3 | LATP | Li2TiO3 | LiNbO3 | LiNbO3 | LiNbO3 | LiNbO3 | LiNbO3 |
| Coating | — | 250 | 250 | 250 | 500 | 1000 | 250 | 30000 | 250 |
| amount of | | | | | | | | | |
| fluoride, | | | | | | | | | |
| ppm | | | | | | | | | |
| Coating | — | 5000 | 5000 | 5000 | 2500 | 25000 | 200 | 500 | 5000 |
| amount | | | | | | | | | |
| of ionic- | | | | | | | | | |
| conductor, | | | | | | | | | |
| ppm | | | | | | | | | |
| Coating | — | 300 | 300 | 300 | 300 | 300 | 300 | 300 | 300 |
| temper- | | | | | | | | | |
| ature, °C | | | | | | | | | |
| Residual | 0.4 | 0.2 | 0.2 | 0.2 | 0.2 | 0.2 | 0.2 | 0.2 | 0.2 |
| Li (wt %) | | | | | | | | | |
| Charge | 246 | 250 | 250 | 250 | 248 | 245 | 248 | 245 | 243 |
| capacity, | | | | | | | | | |
| mAh/g | | | | | | | | | |
| Discharge | 221 | 228 | 226 | 226 | 226 | 223 | 225 | 223 | 220 |
| capacity, | | | | | | | | | |
| mAh/g | | | | | | | | | |
| 10 C | 60 | 78 | 73 | 73 | 74 | 73 | 73 | 68 | 63 |
| rate, % | | | | | | | | | |
| Initial | 40 | 11 | 15 | 16 | 16 | 18 | 20 | 23 | 25 |
| impedance, Ω | | | | | | | | | |
| Post-cycle | 620 | 255 | 320 | 313 | 300 | 380 | 432 | 480 | 530 |
| impedance, Ω | | | | | | | | | |
| Cycle | 68 | 90 | 85 | 85 | 85 | 80 | 77 | 82 | 70 |
| retention | | | | | | | | | |
| rate, % | | | | | | | | | |

| | CE 3 | CE 4 | CE 5 | CE 6 | CE 7 | CE 8 | CE 9 |
|---|---|---|---|---|---|---|---|
| Washing | Maleic | Maleic | Maleic | Maleic | Maleic | Maleic | Maleic |
| medium | acid | acid | acid | acid | acid | acid | acid |
| Distribution | One layer, island-like distribution | | | | | Two layers | Two layers |
| state | | | | | | (outer layer | (outer layer |
| of coatings | | | | | | of conductor, | of fluoride, |
| | | | | | | and inner | and inner |
| | | | | | | layer of | layer of |
| | | | | | | fluoride) | conductor) |
| Coating | — | AlF3 | AlF3 | LiNbO3 | LiNbO3 | AlF3 + | AlF3 + |
| | | | | | | LiNbO3 | LiNbO3 |
| Coating | — | 5000 | 10000 | — | — | 250 | 250 |
| amount of | | | | | | | |
| fluoride, | | | | | | | |
| ppm | | | | | | | |
| Coating | — | — | — | 10000 | 20000 | 5000 | 5000 |
| amount | | | | | | | |
| of ionic- | | | | | | | |
| conductor, | | | | | | | |
| ppm | | | | | | | |
| Coating | 300 | 300 | 300 | 300 | 300 | 300 | 300 |
| temper- | | | | | | | |
| ature, °C | | | | | | | |
| Residual | 0.2 | 0.2 | 0.2 | 0.2 | 0.2 | 0.2 | 0.2 |
| Li (wt %) | | | | | | | |
| Charge | 244 | 243 | 240 | 244 | 242 | 244 | 244 |
| capacity, | | | | | | | |
| mAh/g | | | | | | | |
| Discharge | 222 | 220 | 215 | 222 | 221 | 222 | 222 |
| capacity, | | | | | | | |
| mAh/g | | | | | | | |
| 10 C | 65 | 63 | 61 | 66 | 66 | 67 | 67 |
| rate, % | | | | | | | |
| Initial | 28 | 33 | 38 | 27 | 33 | 35 | 30 |
| impedance, Ω | | | | | | | |
| Post-cycle | 553 | 576 | 652 | 530 | 518 | 565 | 510 |
| impedance, Ω | | | | | | | |
| Cycle | 65 | 70 | 72 | 66 | 68 | 72 | 67 |
| retention | | | | | | | |
| rate, % | | | | | | | |

It can be seen from the test results that the present application achieve the following technical effects according to an embodiment:
by comparing examples 1-4 with comparative examples 1-9, it can be seen that after the positive electrode material of the present application is washed with an organic acid, only a trace amount of alkaline substances remain on the surface, thereby avoiding air generation problem during charging and discharging; a co-coating layer of inert fluoride and fast ion conductor is used, wherein the inert fluoride increases the particle strength, improves the cycle stability, and inhibits side reactions; the fast ion conductor increases the ionic conductivity, accelerates ion transmission, and reduces charge impedance; these factors together improve the performance of the positive electrode material of the present application, including charge and discharge capacity, capacity retention rate at 10 C rate, post-cycle impedance, and capacity retention rate. In particular, compared with an unwashed and uncoated positive electrode material (Comparative Example 1), a water-washed and coated positive electrode material (Comparative Example 2), an acid-washed and uncoated positive electrode material (Comparative Example 3), an acid-washed and only fluoride-coated positive electrode material (Comparative Examples 4-5), an acid-washed and only ionic conductor-coated positive electrode material (Comparative Examples 6-7), and a positive electrode material which uses acid-washing and coatings of fluoride and ionic conductor but has a coating distribution different from that of the present application (Comparative Examples 8-9), the positive electrode material of the present application has improved performance.

It can be seen by comparing Examples 1-7 that when the amount of the fast ion conductor lithium salt compound is 1-20 times of the mass of the inert fluoride, and/or the amount of the inert fluoride is greater than 0 and less than or equal to 1000 ppm, it is advantageous in further improving of the performance of the positive electrode material of the present application.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode material for a lithium ion battery, the positive electrode material comprising:
a positive electrode active material; and
an organic acid lithium salt, a fast ion conductor lithium salt compound, and an inert fluoride which coat particles of the positive electrode active material;
wherein the organic acid lithium salt is in contact with a secondary particle surface and a primary particle grain boundary of the positive electrode active material, the inert fluoride and the fast ion conductor lithium salt compound are dispersed on the secondary particle surface of the positive electrode active material and are both in contact with the secondary particle surface of the positive electrode active material, and the inert fluoride and the fast ion conductor lithium salt compound are in contact with each other.

2. The positive electrode material for the lithium ion battery according to claim 1, wherein the positive electrode active material is a high-nickel positive electrode material of a general formula LiNiₓM_{y}O₂, where x+y=1, 0.6≤x≤1, 0≤y≤0.4, and M is selected from one or more of Co, Mn, Al, Mg, Ti, Fe, Cu, Zn, Ga, Zr, Mo, Nb and W.

3. The positive electrode material for the lithium ion battery according to claim 1, wherein the organic acid lithium salt is a product of reaction between an organic acid and one or both of LiOH and Li₂CO₃ contained in the positive electrode active material, wherein the organic acid has a chemical formula of CₓH_{y}O_{z}, where 1≤x≤10, 2≤z≤4, and the organic acid includes 1 to 3 carboxyl groups and 0 to 1 C═C double bonds.

4. The positive electrode material for the lithium ion battery according to claim 3, wherein the organic acid comprises one or more of maleic acid, acrylic acid, fumaric acid, malonic acid, oxalic acid, and malic acid.

5. The positive electrode material for the lithium ion battery according to claim 1, wherein the inert fluoride is a crystalline compound and has a chemical formula of MₓF_{y}, where M is selected from one or more of Al, Mg, Ca, Fe, La, Li, Ce, and Sr, and x and y are greater than 0.

6. The positive electrode material for the lithium ion battery according to claim 1, wherein the fast ion conductor lithium salt compound is a crystalline compound, and is selected from one or more of lithium aluminum titanium phosphate (LATP), lithium lanthanum titanate (LLTO), lithium lanthanum zirconium oxide (LLZO), and LiₓMO_{y}, where M is selected from one or more of Ti, Zr, Nb, and Ta, and x and y are greater than 0.

7. The positive electrode material for the lithium ion battery according to claim 1, wherein relative to a mass of the positive electrode active material, the inert fluoride has an amount of more than 0 and less than or equal to 1000 ppm.

8. The positive electrode material for the lithium ion battery according to claim 7, wherein the fast ion conductor lithium salt compound has an amount which is 1 to 20 times a mass of the inert fluoride.

9. A method for preparing the positive electrode material for a lithium ion battery, the method comprising:
milling the inert fluoride and the fast ion conductor lithium salt compound to nanoscale particles;
mixing the milled inert fluoride and fast ion conductor lithium salt compound, an organic acid and a non-aqueous solvent to obtain a mixed solution;
adding the positive electrode active material into the mixed solution and stirring;
filtering the mixed solution to obtain a mixture; and
drying, milling and sieving, and calcining the mixture to obtain the positive electrode material,
wherein the positive electrode material includes:
a positive electrode active material; and
an organic acid lithium salt, a fast ion conductor lithium salt compound, and an inert fluoride which coat particles of the positive electrode active material;
wherein the organic acid lithium salt is in contact with a secondary particle surface and a primary particle grain boundary of the positive electrode active material, the inert fluoride and the fast ion conductor lithium salt compound are dispersed on the secondary particle surface of the positive electrode active material and are both in contact with the secondary particle surface of the positive electrode active material, and the inert fluoride and the fast ion conductor lithium salt compound are in contact with each other.

10. A positive electrode for a lithium ion secondary battery, wherein the positive electrode for the lithium ion secondary battery comprises the positive electrode material for a lithium ion battery according to claim 1.

11. A lithium ion secondary battery comprising:
a positive electrode,
a negative electrode, and
a separator,
wherein the positive electrode comprises the positive electrode material for a lithium ion battery according to claim 1.
